(19) United States
(12) Patent Application Publication
(10) Pub. No.: US 2024/0376001 A1
(43) Pub. Date: Nov. 14, 2024

(54) LOW ENERGY-CONTENT CONCRETE WITH RECYCLED OR MANUFACTURED AGGREGATE

(71) Applicants: Whitney B. Belkowitz, Chicago, IL (US); Samuel-James Belkowitz, Chicago, IL (US); William Archie Joseph Shetterley, Noblesville, IN (US)

(72) Inventors: Whitney B. Belkowitz, Chicago, IL (US); Samuel-James Belkowitz, Chicago, IL (US); William Archie Joseph Shetterley, Noblesville, IN (US)

(21) Appl. No.: 18/196,675

(22) Filed: May 12, 2023

(51) Int. Cl. C04B 14/06; C04B 18/167; C04B 20/02

(52) U.S. Cl. CPC C04B 14/062; C04B 18/167; C04B 20/02

(57) ABSTRACT

In an embodiment of the disclosed principles, a process is provided for the treatment of aggregate to yield a treated aggregate product usable in the production of concrete for construction. In general, without affecting the specificity of the claims, the process entails combining an aggregate, such as a recycled aggregate, with an H-CS-C solution and mixing the combination to yield the treated aggregate product.

### TECHNICAL FIELD

The present disclosure is related generally to environmentally-friendly construction technology and, more particularly in an embodiment of the described principles, to a system and method for preparing and using non-cementitious materials in cement to lower cost and energy consumption.

### BACKGROUND

The use of recycled and/or manufactured materials as all or a portion of the coarse and/or fine aggregate components of concrete can have a negative impact on the final product. At the same time, the use of such materials would be an important step in reducing the energy-cost associated with and embodied in construction projects. The primary issues include chemical attack and physical attack.

With respect to chemical attack, it is known that recycled and manufactured aggregates can contain deleterious materials, such as waste products or contaminants resulting from the process used to recycle aggregate. Such contaminants are thought to interact with components of the alkaline environment of the cementitious matrix that makes up the concrete composite. Chemical attack can be, for example, a manifestation of an alkali-silica reaction, sulfate attack, or chloride attack. Many of these chemical mechanisms can result in an expansion of the aggregate from the contaminant or some other component in the composite. The damage is further manifested in the creation of residual stresses within the concrete composite via such expansion, which may overcome the tensile and shear capacity of the concrete. This phenomenon can ultimately lead to failure of the composite at the localized site, and as more localized failure sites are created, crack length increases, and the concrete composite fails from within the matrix.

With respect to physical attack, this may be manifested by absorption due to aggregate, resulting in a loss of moisture intended for hydration. Additional water may therefore be needed for hydration for workability of the concrete and fluid binder content is a phenomenon induced by the high water absorption/adsorption of recycled and manufactured materials. In may cases, recycled materials, such as, for example, recycled and crushed concrete aggregate, have a water absorption/adsorption which is higher than non-recycled materials for reasons including, but not necessarily limited to, 1) properties of the parent material from which the aggregate is recycled (such as, for example, materials having a high water permeability), and 2) high surface area, such as may result from the manufacturing and crushing steps involved in the recycled aggregate production process. These mechanisms may lead to a monopolization (the absorption) of paste and water that ordinarily would have increased workability, as well as paste and water that would have served to increase hydration, development of strength, and development of durability for service-life design.

The absorption may be exacerbated by an increased amount of manufactured fines, clay particles and organics left on the material surface, or other contaminants from the original manufacturing process or the reclamation process. Such contaminants generally affect the availability of water by the absorption phenomena discussed herein, as well as by chemical interactions with chemical waste products and contaminants as discussed herein.

Certain techniques have been attempted to mitigate the foregoing issues, e.g., grading and washing the recycled and manufactured aggregate. However, such solutions have, to date, been less than ideally effective.

Before proceeding, it should be appreciated that while the present disclosure is directed to a system that may address some of the shortcomings listed or implicit in this Background section, any such benefit is not a limitation on the scope of the disclosed principles, or of the attached claims, except to the extent expressly noted in the claims.

Additionally, the discussion of technology in this Background section is reflective of the inventors' own observations, considerations, and thoughts, and is in no way intended to accurately catalog or comprehensively summarize any prior art reference or practice. As such, the inventors expressly disclaim this section as admitted or assumed prior art. Moreover, the identification herein of one or more desirable courses of action reflects the inventors' own observations and ideas, and should not be assumed to indicate an art-recognized desirability.

### SUMMARY

In an embodiment of the disclosed principles, a system and process are provided for the treatment of aggregate to yield a treated aggregate product usable in the production of concrete for construction. In general, without affecting the specificity of the claims, the process entails combining an aggregate, such as a recycled aggregate, with an H-CS-C (Headwater and CS combination) solution and mixing the combination to yield the treated aggregate product.

In an embodiment, a process is provided for the treatment of aggregate for use in concrete, including providing a recycled aggregate, providing an H-CS-C solution, and combining the aggregate and the H-CS-C solution to yield a treated aggregate product usable in the production of concrete for construction.

In a further embodiment, the aggregate includes at least one of virgin aggregate and recycled aggregate, and in another aspect may include one or both of natural aggregate and manufactured aggregate. Combining the aggregate and the H-CS-C solution to yield a treated aggregate product may include mixing the aggregate and the H-CS-C solution together.

In an embodiment, application of the H-CS-C solution to the aggregate includes spraying the H-CS-C solution onto a quantity of the aggregate. In another embodiment, application of the H-CS-C solution to the aggregate includes pouring the H-CS-C solution onto a quantity of the aggregate.

Other features and aspects of the disclosed principles will be apparent from the detailed description taken in conjunction with the included figures.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a chart showing a baseline mortar mix used in the examples;

FIG. 2 is a chart showing colloidal silica dosing in accordance with embodiments of the disclosed principles;

FIG. 3 is a chart showing resulting slump values in accordance with embodiments of the disclosed principles; and

FIG. 4 is a chart showing resultant compressive strength values in accordance with embodiments of the disclosed principles.

### DETAILED DESCRIPTION

As noted above, the use of recycled and/or manufactured materials as all or a portion of the coarse and/or fine aggregate components of concrete can have a negative impact on the final product. At the same time, the use of such materials would be an important step in reducing the energy-cost associated with and embodied in construction projects. In order to address the drawbacks of using such materials, a system and method are disclosed for using colloidal silica (CS) as part of a presoak for recycled construction, municipal, manufacturing waste materials and natural quarried, mined and dredged materials to be used as coarse and fine aggregate and filler material in concrete (granular skeleton), grout, mortar, and other cement composites (from here on referred to as concrete). A presoak is also provided for aggregate products and fillers to be used under road bases.

With this overview in mind, we turn now to a more detailed discussion of the disclosed principles. The general goal is to modify the aggregate before it is mixed with the concrete raw materials to reduce the impact of high absorption, fine content or contaminants that may have a negative impact on the fresh and hardened properties of concrete. The inventors have observed that premature failure of the concrete which is made from recycled and manufactured materials often appears to be a result of attempts to control (improve), through the use of additional water, the fresh concrete properties that are often compromised by the use of recycled and manufactured aggregate. By adding more water to the fresh concrete in order to compensate for water that is lost to absorption, the matrix of the concrete composite may weaken the concrete and cause long term issues with respect to hardened properties.

The mechanism by which the above issues are addressed herein involves the creation of a CS-based hydrogel or three-dimensional structures that retain pore water solution from the cementitious-water combination in the concrete matrix and the CS that is premixed with head water, and the granular skeleton that can be made up of natural, recycled, and manufactured aggregate. Before the CS is added to the aggregate, the CS is a dispersion of nano-silica sized particles, nano-gels, and micro-gels. The combination of these is dependent on the CS manufacturing process type and quality as will be appreciated by those of skill in the art. Different combinations of CS dispersion can be used with silicate solutions, and different modifications based on the alkalinity and contaminants contained within the aggregate.

As used herein, the term Nano-sized silica particles within the colloidal suspensions refer to particles of size ranging from 1 to 1000 nm. The Solid Content of the CS can range from about 50% and below. The pH of the CS may range from acidic (less than 4 and up to 7), neutral (7), to basic (7 and above).

Small Particles of Colloidal Silica may measure, in nm:
Narrow: 1-3, 3-5, 6-8, 10-12, 17-19, . . .
Wide: 3-10, 3-20, 5-20, . . .

Large Particles of Colloidal Silica may measure, in nm:
Narrow: 45-47, 50-55, 70-75, 10-12, 17-19, . . .
Wide: 3-100, 50-75, 100-500,

The term Non-Modified (STD) connotes NaO2 Stabilized, whereas Modified (Alumina (AL), Lithium, Silane etc.) are stabilized with a salt (NaO2). A modification can cover all or part of the particles and there can be multiple modifications on one particle.

The following sequence of events should be used to deploy the CS. Aggregate is added to mixer, with the mixer revolving at mixing speed. The Headwater and CS combination (H-CS-C) is added to the aggregate at mixing speed.

At this point, the H-CS-C absorbs and adsorbs into the recycled or manufactured aggregate. Further, during mixing, the H-CS-C polymerizes into hydrogels which contain pore water solution and nano-sized silica particles. Early gel formation may provide little to no strength but does offer a reservoir of water to be used for later hydration. Early gelling of the aggregate at surface, sub-surface, and body cuts off the mechanisms that would lead to a monopolization of the paste and a need to add water on the jobsite. The reservoirs of water within the recycled or manufactured aggregate will be used later to enhance the interfacial zone between the aggregate and the hydrated cementitious matrix.

Adding the CS (or CS combinations or CSs and headwater combinations) at the right time at the mixer can have a beneficial effect. In an embodiment, the aggregate is discharged into the ready-mix truck to a dry batch plant, the central plant mix, wet batch plant, volumetric mixer, or laboratory mixer, but there is a myriad of ways to introduce CS into the mixer. The CS can be sprayed or mixed as a CS-water combination in standard sequencing during the initial stages of mixing before the components for the paste (or binder or matrix) of the concrete composite. The sequence can be done manually, dumped with a 5-gallon bucket; it can be done with a sprinkler; undertaken by an automated sprayer with a garden hose; or even in the automated distribution centers at automated facilities.

After the CS is combined with the headwater (or just a portion of the headwater) and the recycled or manufactured aggregate, they are mixed for 30 to 60 seconds or longer. A time of 30-60 seconds at 18 RPM, +/−5 RPM in the mixer, during the critical path of conventional concrete composite manufacturing has been found to be beneficial. This process can be done with either coarse or fine aggregate, whether solely recycled and manufactured or virgin and natural combination.

Applying the CS to the aggregate material may be accomplished in other ways as well. For example, H-CS-C may be topically applied to both recycled and virgin aggregate combinations before being mixed into concrete. The mixture can include solely manufactured or natural elements, as well as any combination thereof. Alternatively, the H-CS-C may be added to the aggregate, without agitation, when the aggregate is still in storage piles. In this embodiment, the H-CS-C may be applied via sprinkler systems, topically applied to the aggregate when it is being transported up the belt into the concrete mixer, topically applied with a spray bar over the weigh up hopper, and so on. The application of H-CS-C may be executed by combination of H-CS-C with the recycled or manufactured aggregate in a pile before concrete composite manufacturing.

Selecting the correct CS (or CS combinations or CSs and headwater combinations) at the mixer also affects the beneficial properties yielded by embodiments of the invention. The more porous the aggregate and the greater the pore connectivity, the wider the distribution of nano-silica sized particles in the CS is needed. Moreover, softer aggregate (e.g., some limestones, recycled concrete) with a greater content of larger pores, with or without greater pore connectivity, will benefit from a CS dominated with larger particles in the wide distribution. A denser aggregate (denser parent material) with a larger pore content (smaller pores and pore connectivity) will benefit from a CS dominated with smaller particles in the wide distribution.

Denser aggregate (e.g., granite, ceramics, or porcelain) with a lower number of larger pores and pore connectivity will benefit from a smaller particle size distribution of smaller particles. The greater the fines in the recycled and manufactured media, the wider the beneficial distribution of particles to accommodate for the surface area and increased number of particles with higher surface area.

Likewise, the more alkaline an aggregate is, the larger the particle and the more modifications needed on the nano-sized silica particles for the aggregate presoak (e.g., an alumina, alumina-lithium, or silane). The larger and more modified particle will through slower a polymerization/gelling process that a smaller, non-modified particle would in a more alkaline environment.

There are some aggregates that contain a large proportion of soluble earth alkaline metals in the form of, e.g., sodium, potassium, calcium, chlorides, etc. Those that will change the pH of the CS dispersions will cause destabilization. However, it is not ideal that the CS immediately destabilizes (polymerizes/gels) at the surface the recycled or manufactured aggregate; rather there should be some depth of penetration to create an internal locking of water for an internal curing of concrete later on in the concrete (not at the surface) at the interfacial zone between the aggregate and concrete matrix.

In general, the treated aggregate provided by the foregoing is then usable as ordinary aggregate would be used in the preparation of concrete. In an additional embodiment, the aggregate is used in concrete which is prepared as described in US Published application Ser. No. 20/200062659, which describes the tailwater addition of further amounts of colloidal silica, to give still further advantages, and which is herein incorporated by reference in its entirety for all that it teaches, shows and suggests, without exclusion of any part or portion thereof.

The term “Aggregate” includes, as is understood in the art, coarse and/or fine aggregate (large and/or small aggregate as understood in the art, such as aggregate pieces in the range of from about 0.25 inch to about 2.0 inch corresponding to coarse aggregate and aggregate pieces in the range understood in the art corresponding to fine aggregate). In an embodiment, additional sand (coarse aggregate) is added to concrete which includes the treated aggregate. It should be noted that the proportions of aggregate given below with respect to the preparation of treated aggregate do not include aggregate (sand) added during further steps in the preparation of the concrete.

In general, the invention includes the formation of a treated aggregate by a process which comprises the contacting of aggregate with water and colloidal silica, and providing a degree of agitation (such as, for example, with a mixer). In an embodiment, the colloidal silica is mixed with the water (“H-CS-C”) and the mixture is contacted with the aggregate, in another embodiment, some or all of the aggregate is in the mixer at the time of contacting. In yet another embodiment, water is added to the aggregate, optionally, with agitation of the water and aggregate during or after the addition, followed by the addition of CS, with agitation of the mixture comprising aggregate/water/CS optionally during some or all of the addition time, followed by agitation after the addition of the CS. In yet other embodiments, the water, CS and aggregate can be added simultaneously, with agitation occurring after, and optionally, during the addition. In still other embodiments, some or all of the water and/or some or all of the CS can be added to a mixer first, either separately or as a mixture (H-CS-C).

In certain embodiments, the water and aggregate are contacted before CS is present. The contacting preferably takes place with agitation, such as with a mixer. Aggregate can be added to mixer, which can be revolving at mixing speed at the time of addition, or the mixer can be started after the addition of the aggregate. For example, the aggregate can be discharged into the ready-mix truck to a dry batch plant, the central plant mix, wet batch plant, volumetric mixer, or laboratory mixer. The CS can be introduced into the mixer in one or more of numerous ways. For example, as noted above, the CS can be sprayed or mixed as a CS-water combination in standard sequencing during the initial stages of mixing before the components for the paste (or binder or matrix) of the concrete composite. The sequence can be performed manually, such as dumped with a 5-gallon bucket; it can be done with a sprinkler; undertaken by an automated sprayer with a garden hose; or even in the automated distribution centers at automated facilities.

In a preferred embodiment, the H-CS-C is added to aggregate at mixing speed (i.e., a speed in the range of from about 13 to about 23 revolutions per minute). Upon the combination of H-CS-C with the recycled or manufactured aggregate, they are mixed at one or more of the foregoing speeds for 30 to 60 seconds or longer during the critical path of conventional concrete composite manufacturing. This process can be done with either or both of coarse and/or fine aggregate. The aggregate can be solely recycled and manufactured or virgin and natural aggregate combination--any combination of recycled and virgin aggregate may be used, whether manufactured or natural in origin.

From a theoretical standpoint, it is thought that H-CS-C absorbs and adsorbs into the pores of the recycled or manufactured aggregate, facilitating an improved binding of the aggregate to the cement matrix. It is thought that the mixing facilitates the polymerization of H-CS-C into hydrogels. The hydrogels contain pore water solution and nano-sized silica particles. It is thought that a primary effect of such early gel formation is not necessarily to provide appreciable strength, but to provide a reservoir of water to be subsequently used for hydration farther along in the curing process. Furthermore, it is thought that early gelling at the aggregate surface, sub-surface, and body attenuates the mechanisms that would be expected to lead to the sequestering away of some or all of the water in the cement paste present in the concrete mix. Such sequestering could be expected to make necessary the addition of still additional amounts of water, usually, for example, at the job site. It is thought that the reservoirs of water mentioned above which are thought to be within the recycled or manufactured aggregate function later to enhance the interfacial zone between the aggregate and the hydrated cementitious matrix.

### EXAMPLES

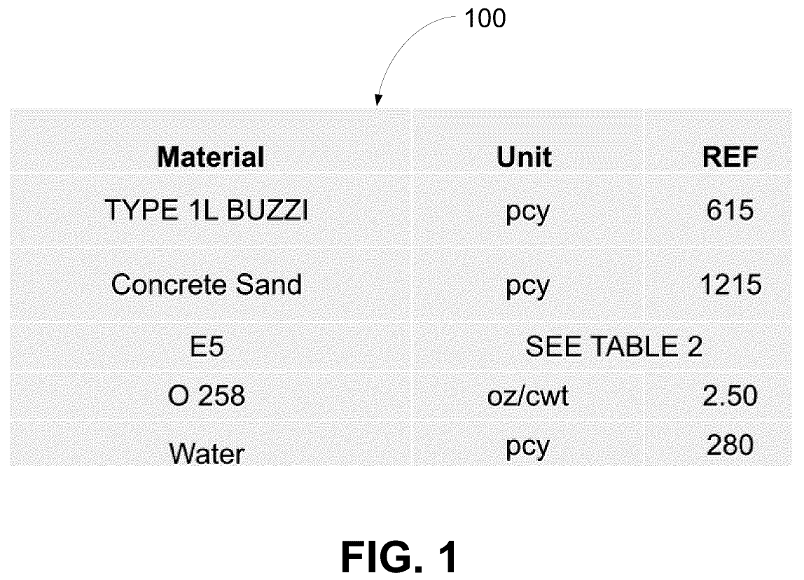

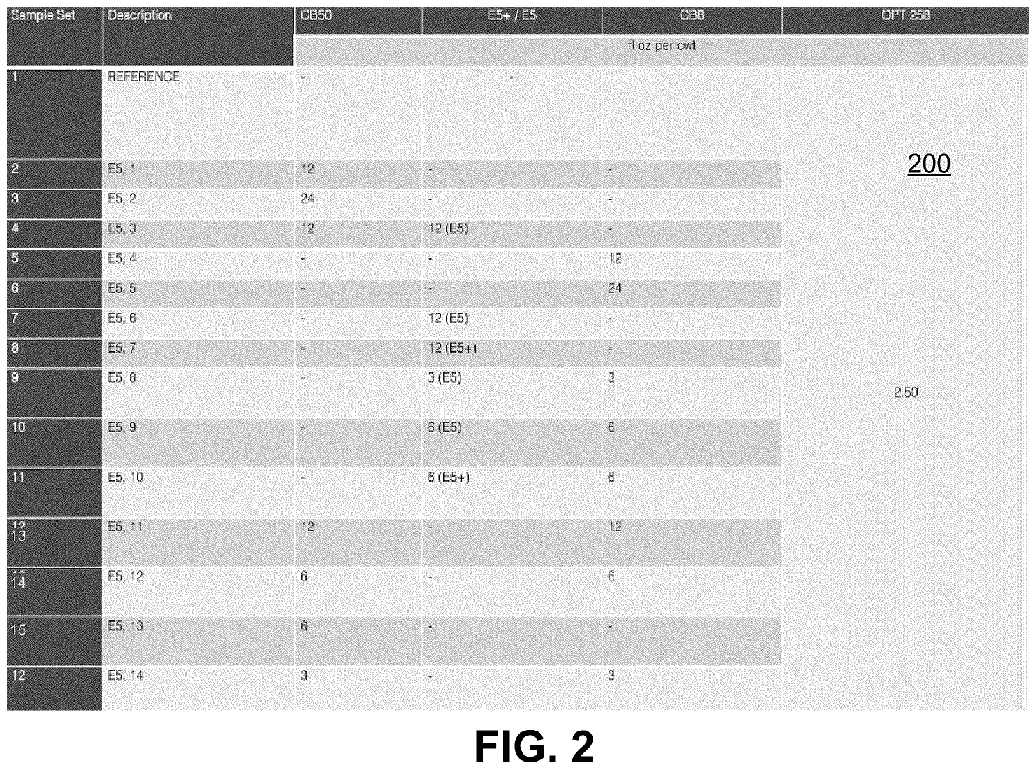

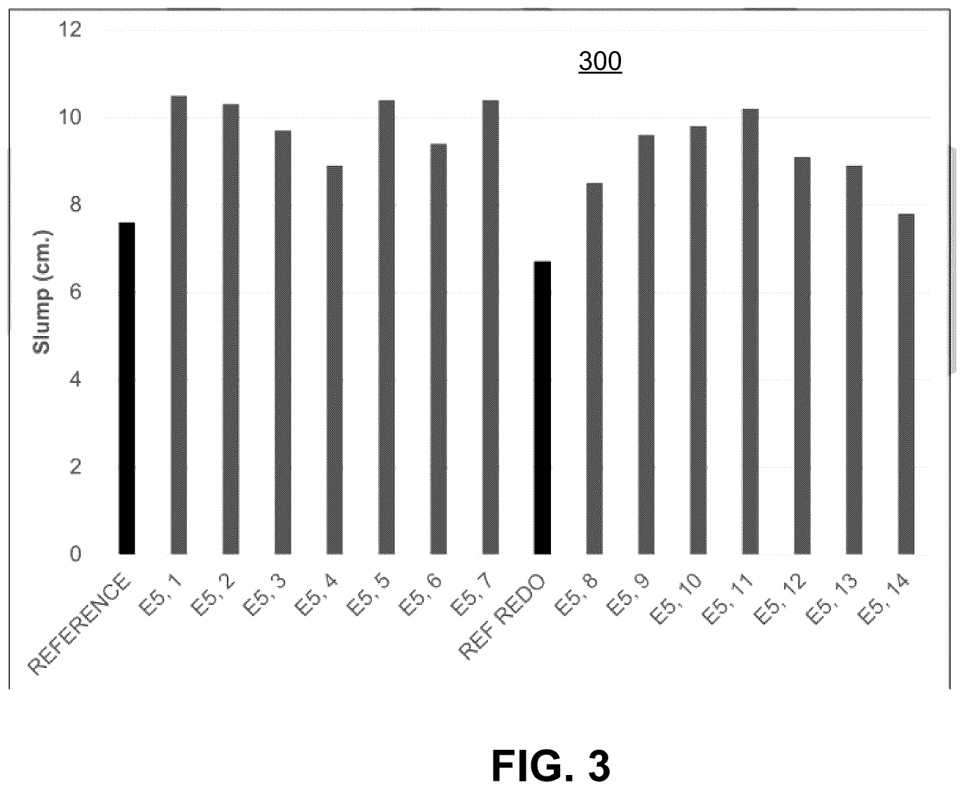

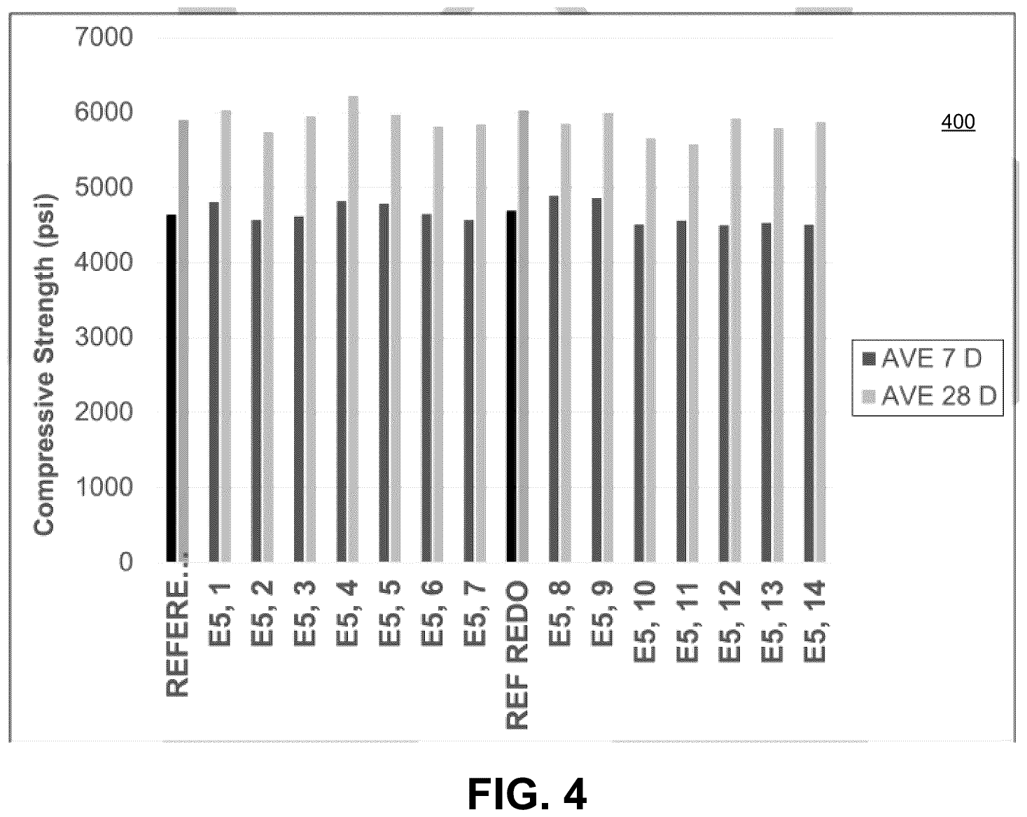

Turning to several examples of the disclosed system, fourteen (14) mixes were prepared and compared to a reference mix using the baseline mortar mix shown in chart 100 of FIG. 1. The colloidal silica dosing was made as per the chart 200 of FIG. 2. The resulting slump values of these trials were as shown in the chart 300 of FIG. 3, and the resultant compressive strength values were as shown in the chart 400 of FIG. 4. As can be seen, the mix denoted #8, which had a wide distribution of non-modified nano-silica, had the most efficiency impact on the use of the crusher fines. However, all mixes show beneficial characteristics, and the invention does not require the most optimal or ideal use of its teaching, but merely the beneficial use thereof.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “such that,” and “operable to” do not imply any particular tangible or intangible modification of a subject, but, rather, are intended to be used interchangeably. A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology.

A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The words “exemplary,” “exemplify,” and “example” are used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

Reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub combination or variation of a sub combination.

It will be appreciated that various systems and processes have been disclosed herein. However, in view of the many possible embodiments to which the principles of the present disclosure may be applied, it should be recognized that the embodiments described herein with are meant to be illustrative only and should not be taken as limiting the scope of the claims. Therefore, the techniques as described herein contemplate all such embodiments as may come within the scope of the following claims and equivalents thereof.

We claim:

1. A process for the treatment of aggregate for use in concrete, said process comprising the steps of:
providing a recycled aggregate;
providing a headwater and colloidal silica solution (H-CS-C);
combining the aggregate and the H-CS-C solution and mixing to yield a treated aggregate product usable in the production of concrete for construction.

2. The process for the treatment of aggregate in accordance with claim 1, wherein the aggregate includes at least one of virgin aggregate and recycled aggregate.

3. The process for the treatment of aggregate in accordance with claim 1, wherein the aggregate includes at least one of natural aggregate and manufactured aggregate.

4. The process for the treatment of aggregate in accordance with claim 1, wherein the step of combining the aggregate and the H-CS-C solution to yield a treated aggregate product includes mixing the aggregate and the H-CS-C solution together.

5. The process for the treatment of aggregate in accordance with claim 1, wherein the step of combining the aggregate and the H-CS-C solution to yield a treated aggregate product includes spraying the H-CS-C solution onto a quantity of the aggregate.

6. The process for the treatment of aggregate in accordance with claim 1, wherein the step of combining the aggregate and the H-CS-C solution to yield a treated aggregate product includes pouring the H-CS-C solution onto a quantity of the aggregate.

7. The process for the treatment of aggregate in accordance with claim 1, wherein the colloidal silica of the H-CS-C solution includes silica particles of size ranging from about 1 to about 1000 nm.

8. The process for the treatment of aggregate in accordance with claim 1, wherein the colloidal silica of the H-CS-C solution has a solid content of about 50% or lower.

9. The process for the treatment of aggregate in accordance with claim 1, wherein the colloidal silica of the H-CS-C solution has a pH range from acidic to basic.
